(19) United States
(12) Patent Application Publication
(10) Pub. No.: US 2007/0206584 A1
(43) Pub. Date: Sep. 6, 2007

(54) Systems and methods for providing a dynamic interaction router

(76) Inventors: Stephen W. Fulling, South Jordan, UT (US); David B. McNamee, Farmington, UT (US); Phillip J. Windley, Lindon, UT (US); Lee G. Jensen, Midvale, UT (US); Steve Spigarelli, West Jordan, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/700,540

(22) Filed: Jan. 30, 2007

Related U.S. Application Data
(60) Provisional application No. 60/764,141, filed on Jan. 31, 2006.
(60) Provisional application No. 60/832,636, filed on Jul. 21, 2006.

(51) Int. Cl. H04L 12/66

(52) U.S. Cl. 370/356

(57) ABSTRACT

Systems and methods for providing intelligent routing of customer inquiries via multi-channel communication tools. A dynamic router is provided that embraces interaction and manages resources of a back end system out to a portal. Such interaction can be via a chat session, a webpage, a telephone, or another manner of communication. When an individual (e.g., a customer or other individual) comes to a portal, the individual is dynamically routed to the preferred channel based on one or more of a variety of factors. A set of rules, customer information, and intelligent analysis combine to dynamically determine how to martial the resources to best service the individual. The routing provides a tailored experience specific to the particular individual rather than a static behavior that everyone would experience, and ensures that the communication takes place in a language that is desired by the individual.

### RELATED APPLICATIONS

This application claims priority to U.S. Provisional Patent Application Ser. No. 60/764,141 filed Jan. 31, 2006, entitled SYSTEMS AND METHODS FOR PROVIDING A DYNAMIC INTERATION ROUTER, and to U.S. Provisional Patent Application Ser. No. 60/832,636 filed Jul. 21, 2006, entitled SYSTEMS AND METHODS FOR PROVIDING A DYNAMIC INTERACTION ROUTER.

### BACKGROUND OF THE INVENTION

1. Field of the Invention

The present invention relates to providing a dynamic interaction router. In particular, the present invention relates to systems and methods for providing intelligent routing of inquiries via multi-channel communication tools.

2. Background and Related Art

Current technology has allowed customers to interact with businesses in a number of different ways, including via telephone, email, or a webpage. While such technological advancements have provided benefits to businesses, challenges also exist. For example, a call taken by a customer service representative is typically more expensive to a company than having the customer obtain needed information through telephonic menu options. However, customers can experience frustration by becoming lost in telephonic menu options that do not provide needed information and by being unable to communication with a live person. As such, there can be a trade off between the cost incurred and the customer satisfaction engendered.

Similar challenges can be present using electronic communication, including email or a webpage. Some businesses prefer utilization of a live sales person to communicate directly with the customer in order to help consummate a sale. Other businesses desire that their customers are directed to their webpage to minimize live communications.

Thus, while techniques currently exist that are used to allow for interaction between customers and businesses, challenges still exist. Accordingly, it would be an improvement in the art to augment or even replace current techniques with other techniques.

### SUMMARY OF THE INVENTION

The present invention relates to providing a dynamic customer interaction router. In particular, the present invention relates to systems and methods for providing intelligent routing of customer inquiries via multi-channel communication tools.

Implementation of the present invention takes place in association with a router that embraces interaction. Such interaction can be via a chat session, a webpage, a telephone, email, text message, video image, sound file, or other manner of communication. When an individual (e.g., a customer or other individual) comes to a portal, the individual is dynamically routed to the preferred channel based on one or more of a variety of factors. For example, such factors include what is needed by the individual, the frequency of the individual visiting the portal, the type of customer, the type of product that is desired, the type of service that is desired, the level of expertise, a particular communication medium, and other factors.

Based on one or more of the factors, the individual/customer is dynamically routed, for example, to a telephone line, a chat session, or to frequently asked questions on a webpage. Additionally, the routing ensures that the communication takes place in a language that is desired by the individual.

Accordingly, in at least some implementations of the present invention, the interaction router manages resources of a back end system out to a portal. A set of rules, customer information, and intelligent analysis combine to dynamically determine how to martial the resources to best service the customer. Thus, in at least some implementations, a tailored experience specific to the particular customer is provided rather than a static behavior that everyone would experience.

At least some implementations of the present invention relate to a customer experience platform that can build customer loyalty and/or increase sales conversion rates. In at least one implementation, the customer experience platform is a rules-engine that optimizes a website, providing rich customer experiences. Using the platform, customer behaviors are analyzed in real-time and online websites are able to respond rapidly, providing dynamic messaging and offers that motivate customers to take action. The platform's functionality allows customized marketing offers to be delivered at the moment customers are making decisions that affect their loyalty and decision to purchase.

In one implementation, the platform fosters a more positive and seamless experience for customers without requiring costly and time-consuming engineering resources, and allows the system to rapidly deploy the platform regardless of the web platform and without burdening the system support staff. The platform can be installed on any webpage and within minutes the marketing team can dramatically affect the customer experience.

By connecting customers' interactions and behaviors with company data and e-commerce platforms, the platform delivers active personalization and one-to-one marketing. Customers receive offers based on their personal online actions, buying history, geographic location or demographics. For example, different offers can be presented for high-value versus low-value customers, as well as regional considerations such as monthly product inventory levels in one market versus another market. In addition to e-commerce applications, the platform also delivers value for the crucial customer support function.

While the methods, systems and processes of the present invention have proven to be particularly useful in the area of customer service, those skilled in the art can appreciate that the methods, systems and processes can be used in a variety of different applications and in a variety of different arenas to yield dynamic interaction routing. For example, embodiments of the present invention embrace the routing of external inquiries or needs, internal inquiries or needs, multiple professional interactions, business opportunities, and other dynamic routing.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked system configuration for use in association with an embodiment of the present invention for selectively exchanging information across the network;

FIG. 3 illustrates a representative embodiment for providing a customer interaction router in accordance with an embodiment of the present invention;

FIG. 4 illustrates a representative embodiment for a third-party website behavior modification system;

FIG. 5 illustrates a representative embodiment illustrating use of page types in a third-party website behavior modification system;

FIG. 6 illustrates another representative embodiment illustrating use of page types in a third-party website behavior modification system;

FIG. 7 illustrates a representative embodiment illustrating use of bookmarkets to identify page types and/or variables;

FIG. 8 illustrates a representative embodiment illustrating use of Distributed Ruby (DRB) in aggregating data from server clusters into one database;

FIG. 9 illustrates another representative embodiment illustrating use of distributed ruby (DRB) in aggregating data from server clusters into one database; and

FIG. 10 illustrates a representative embodiment illustrating use of an include to manage interactions with a third-party website behavior modification system.

### DETAILED DESCRIPTION OF THE INVENTION

The present invention relates to providing a dynamic customer interaction router. In particular, the present invention relates to systems and methods for providing intelligent routing of customer inquiries via multi-channel communication tools.

Embodiments of the present invention include a router that embraces interaction. Such interaction can be via a chat session, a webpage, a telephone, or another manner of communication. The interaction router manages resources of a back end system out to a portal. Thus, when an individual (e.g., a customer or other individual) visits the portal, a set of rules, customer information, and intelligent analysis combine to dynamically determine how to martial the resources to best service the customer. For example, based on one or more of factors, the individual/customer is dynamically routed, to a telephone line, a chat session, or to frequently asked questions on a webpage. Additionally, the routing ensures that the communication takes place in a language that is desired by the individual. Accordingly, in at least some embodiments, a tailored experience specific to the particular customer is provided rather than a static behavior that everyone would experience.

Embodiments of the present invention include a customer experience platform that builds customer loyalty and/or increases sales conversion rates. Using the platform, customer behaviors are analyzed in real-time and online websites are able to respond rapidly, providing dynamic messaging and customized marketing offers that motivate customers to take action. The customized marketing offers are delivered at the moment customers are making decisions that affect their loyalty and decision to purchase.

Embodiments of the present invention connect customers' interactions and behaviors with company data and e-commerce platforms, and deliver active personalization and one-to-one marketing. Customers receive offers based on their personal online actions, buying history, geographic location or demographics. For example, different offers can be presented for high-value versus low-value customers, as well as regional considerations such as monthly product inventory levels in one market versus another market. The platform also delivers value for crucial customer support functions.

Embodiments of the present invention further embrace a customer experience platform that fosters a more positive and seamless experience for customers without requiring costly and time-consuming engineering resources, and allows the system to rapidly deploy the platform regardless of the web platform and without burdening the system support staff. The platform can be installed on any webpage and within minutes the marketing team can dramatically affect the customer experience. Additional details relating to embodiments of the present invention will be provided in greater detail below.

The following disclosure of the present invention is grouped into two subheadings, namely “Exemplary Operating Environment” and “Providing a Dynamic Interaction Router.” The utilization of the subheadings is for convenience of the reader only and is not to be construed as limiting in any sense.

### Exemplary Operating Environment

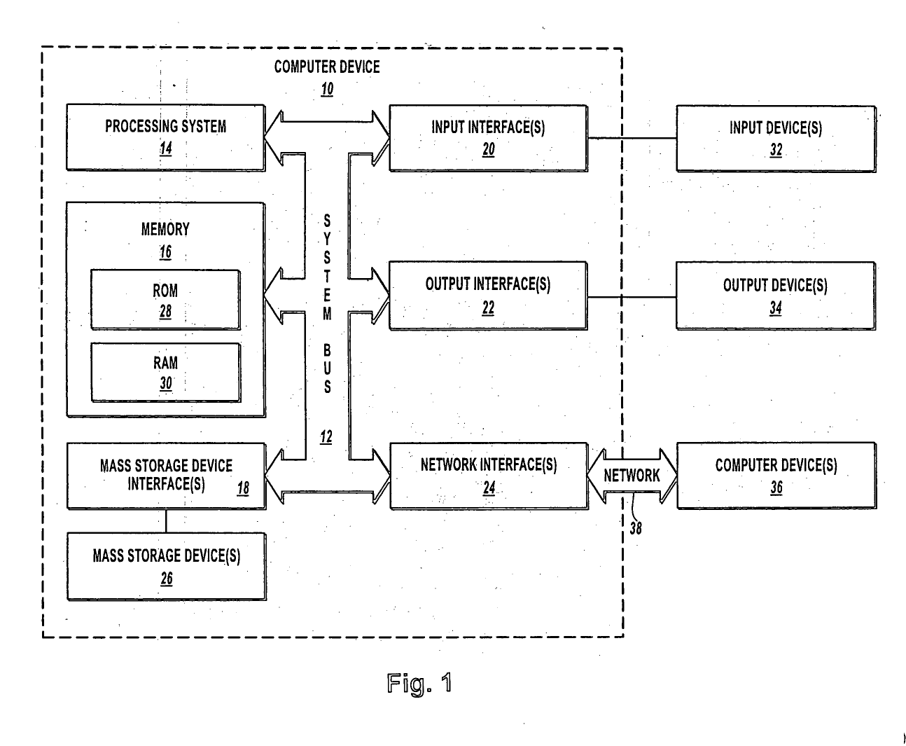

As provided above, the present invention relates to providing a dynamic interaction router. FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a telephone line, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

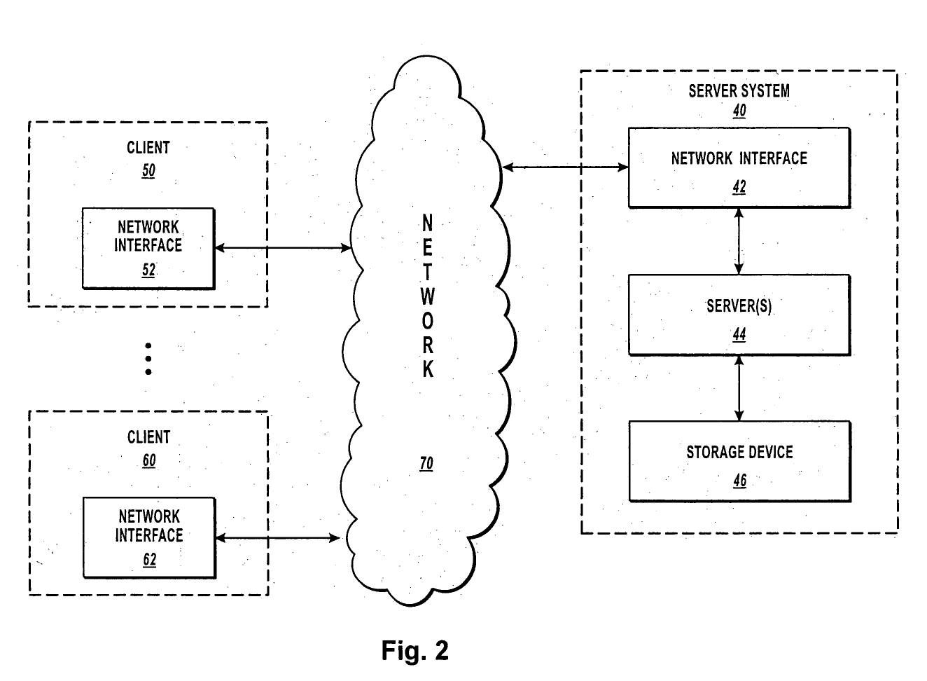

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

In FIG. 2, a representative networked configuration is provided for which interaction can take place across the network. Server system 40 represents a system configuration that includes one or more servers. Server system 40 includes a network interface 42, one or more servers 44, and a storage device 46. A plurality of clients, illustrated as clients 50 and 60, communicate with server system 40 via network 70. A client such as client 50, can be any type of device that allows for interaction via the network. For example, client 50 can be a computer device, a telephone, or another device that allows for interaction across the network. Network 70 may include a wireless network, a local area network, and/or a wide area network. Network interfaces 52 and 62 are communication mechanisms that respectfully allow clients 50 and 60 to communicate with server system 40 via network 70. For example, network interfaces 52 and 62 may be web browsers or other network interfaces. A browser allows for a uniform resource locator (“URL”) or an electronic link to be used to access a web page sponsored by a server 44. Therefore, clients 50 and 60 may independently access or exchange information with server system 40.

As provided above, server system 40 includes network interface 42, servers 44, and storage device 46. Network interface 42 is a communication mechanism that allows server system 40 to communicate with one or more clients via network 70. Servers 44 include one or more servers for processing and/or preserving information. Storage device 46 includes one or more storage devices for preserving information, such as a particular record of data. Storage device 46 may be internal or external to servers 44.

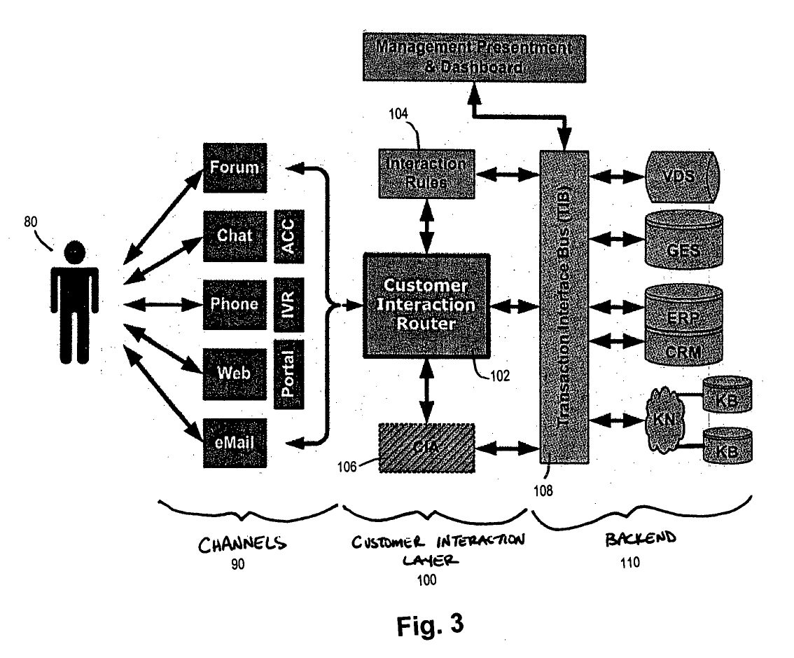

Those skilled in the art will appreciate that the networked system of FIG. 2 is a representative system in accordance with an embodiment of the present invention. Other embodiments of the present invention embrace other system configurations for performing methods disclosed herein. For example, FIG. 3 provides a more particular embodiment for providing a dynamic interaction router, as shall be discussed below.

### Providing a Dynamic Interaction Router

As provided herein, the present invention relates to providing a dynamic interaction router. In particular, the present invention relates to systems and methods for providing intelligent routing of inquiries via multi-channel communication tools.

With reference to FIG. 3, a representative system configuration is illustrated for providing a dynamic interaction router. FIG. 3 includes a customer 80 of a particular business, channels of communication 90, a customer interaction layer 100, and a backend 110. A customer 80 can utilize any of a number of different channels 90 to interact with the system. Such channels can include email, a chat session, the web, telephone, etc. The system includes a customer interaction layer that includes a customer interaction router 102 that dynamically routes the interaction of the customer 80 according to various rules 104 established by a business or manager and customer information (“CIA”) 106 obtained or learned about the customer 80. The customer interaction router 102 also interfaces with a transaction interface bus to manage the backend 110.

Thus, when customer 80 comes to the portal, the customer is provided a custom experience across the desired channel. The dynamic routing takes place based on particular factors or interplay between the interactive rules and customer information. Examples of such factors include the need of the customer, the type of customer, other customer information, preferences of the particular business, etc.

The embodiment of FIG. 3 illustrates a customer interaction router/web portal interaction router. The customer can enter via the internet, telephone, email, or any other way they have of reaching the portal. The customer interaction router manages the resources of the back end system 110 out to the portal. The management is performed based on a set of customizable rules 104, customer information 106, and intelligent analysis to make a determination about how to martial the resources in order to service the customer 80.

The rules 104 can be customized or controlled by the particular business or industry, or by the system manager. The rules are based on preferences of the business on how it desires to interact with its customer. In some embodiments, rather than having to write a program, the business or manager can select rules from a menu and/or drag and drop rules onto the web interface. So then the business or manager can tailor the behavior of the system based on what they want to have happen with their customers and change it with any desired frequency.

The customer information (illustrated as CIA box 106) includes any information know about the customer—for example, particulars about the customer, products owned by the customer, previous purchases, the frequency of visits to the portal, the type of customer, and/or any other customer information. The customer information may also include anything known about this particular visit, such as the trail of pages that the customer has visited.

In one embodiment, customer interaction router 102 utilizes tabs without having to reprogram or without having to even redo the pages. The tabs are added to the website to provide functionality, such as providing offers, deals or incentives based on the particular customer. It is dynamically tailored to each business and customer. The business or manager sets up rule sets according to how they desire to interact with each customer. For example, one business may establish rule sets to encourage less expensive interaction, such as a chat session or web page. Another business can establish rule sets to encourage phone conversations to up-sell and to consummate a sale.

Businesses are able to fine tune the interaction so that the business doesn't have to engage in an expensive call with every customer. Additionally, if the system knows that a customer has been to the portal multiple times and is likely very upset, the business may can make sure that they handle the problem right away by utilizing a priority queue.

Behaviors can be implemented without redeveloping a site. Moreover, the behaviors can be established in real-time. Thus, if something happens during the day, changes can be made very quickly.

In at least some embodiments, the CIR can be utilized in an e-commerce scenario to provide intelligence to the offers of discounts of content presentation and behavior of an e-commerce site through the establishment of marketing and/or merchandising focused rules. Thus, embodiments of the present invention embrace dynamic merchandising. In some embodiments, the dynamic merchandising is provided based on the profile of the customer and/or customer behavior.

Embodiments embrace integrating multiple data sources—driving sites that don't belong to the system manager and that the system manager doesn't have any control over. Dynamic behavior is provided without the ownership of either the backend data or front end website. In one embodiment, the channel routing is dependent on the tagging utilized. Additionally, embodiments of the present invention can tie into brick and mortar interaction.

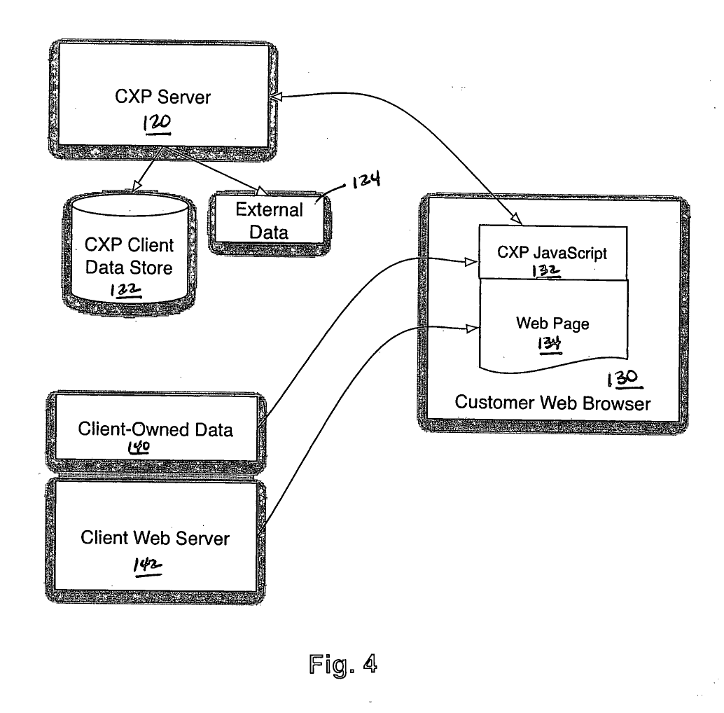

With reference now to FIG. 4, a representative embodiment is provided for a third-party website behavior modification system. In FIG. 4, CXP Server 120 communicates with CXP client data store 122 and external data 124. A customer web browser 130 includes CXP JavaScript 132 and webpage 134. Client owned data 140 and client web server 142 interface respectively with CXP JavaScript 132 and webpage 134. Additionally, CXP server 120 bi-directionally interfaces with CXP JavaScript 132.

The following provides a discussion relating to implementation and use of a dynamic interaction router in accordance with some embodiments of the present invention, including the dynamic presentation and customization of web content based on user behavior, various technologies or interaction channels that can be controlled by a dynamic interaction router, a representative manner for tagging pages to interact with a dynamic interaction router, the performance of interaction routing across multi-channel communication methods, self-learning behavioral capabilities of a dynamic interaction router, and automated variable self-discovery capabilities of a dynamic interaction router.

As provided herein, embodiments of the present invention embrace dynamic presentation and customization of web content based on user behavior. The customer interaction router (“CIR”) customizes and presents web content based on the user's behavior on a customer interaction router instrumented site.

In at least one embodiment, the customer interaction router and the instrumented website are separate web entities. The customer interaction router controls tables, divs, menus, pages, and other named website elements. Selected user behavior is transmitted to the customer interaction router via, for example, AJAX-generated behavior-encoded URLs. These URLs are sent to the customer interaction router via a proxy service on the instrumented website using an HTTP “GET” command. The behavior of users and other information is stored in variables by the customer interaction router server for use in determining if defined conditions are met.

Real-time user behavior is processed by the customer interaction router server and in some cases compared with historical user information or other factors. If the behavior meets a pre-defined condition that the customer interaction router is listening for then the customer interaction router responds to the client browser's HTTP “GET” command with, for example, XML-encoded instructions for the client to execute.

The client browser receives the XML-encoded instructions into a JavaScript-based XML parser. This parser invokes the appropriate action based on the instructions received from the customer interaction router server. This may include hiding a page element, opening a new page, displaying a div with specific content, or changing the options available to the user on a page. Customer interaction router rules are defined using a web interface and are comprised of variables and operators combined to define conditions which, when those conditions are met, trigger customer interaction router behaviors.

Customer interaction router behaviors interact with named elements of the instrumented site or display content from a third party. Customer interaction router behaviors are customized using a web interface. New or modified customer interaction router rules can be deployed to the instrumented site with the click of one button in the web interface. Customer interaction router rules can be made inactive through the web interface.

In accordance with embodiments of the present invention, a dynamic or customer interaction router can control a variety of technologies or interaction channels. The customer interaction router can be used to route interactions and affect the user experience for different interaction technologies or channels such as the following: (i) An Interactive Voice Response system can be controlled by the customer interaction router to add a layer of intelligence and adaptability to the user's experience; (ii) Voice self service systems use technologies that the customer interaction router can control to personalize content presented to the user resulting in an increased degree of relevancy and usefulness of the information presented; (iii) Automated call distribution systems for phone, chat or email can be instrumented with the customer interaction router to route calls; (iv) Any IP-based technology can be instrumented with the customer interaction router; (v) Interactive kiosks and point of sale (POS) interaction devices that are network-enabled can be instrumented with the customer interaction router to manage user interactions; and/or (vi) Set-top boxes used in the delivery of television programming and other entertainment related hardware devices that are networked via IP-based technology can be instrumented with the customer interaction router to manage user interactions.

Those skilled in the art will appreciate that the examples provided above of technologies or interaction channels that can be controlled by a customer interaction router are representative only. Thus, embodiments of the present invention further embrace the controlling of other technologies or interaction channels by use of a customer interaction router. Additionally, those skilled in the art will appreciate that references made to specific languages are representative only. Thus, embodiments of the present invention further embrace the utilization of other languages to provide or otherwise utilize a dynamic customer interaction router in accordance with the present invention.

As provided herein, embodiments of the present invention embrace tagging resources, such as pages, to interact with a customer interaction router. In some embodiments, the technologies used to create a customer interaction router include Object-Oriented JavaScript, AJAX HTTP, XML, Ruby, Rails, and Rein. Pages on the instrumented site are modified to include four JavaScript files. Three of the JavaScript files assist the site in executing commands received from the customer interaction router server. One of the JavaScript files sends AJAX-generated behavior-encoded URLs via HTTP “GET” to the customer interaction router server and receives and parses XML-encoded instructions that are sent by the customer interaction router server in response. The four JavaScript includes are the interface through which data are passed between the instrumented site and the customer interaction router server and provide tools for displaying content or controlling the user's experience.

In addition to the JavaScript includes, each page that will interact with the customer interaction router is tagged with JavaScript that executes on the triggering of any event handler (such as onpageload, onclick, etc.) and spurs the include file to generate messages to the customer interaction router server, known as customer interaction router events. Customer interaction router events feed information to the customer interaction router server, which records the information and evaluates the new information and other historical information to determine whether any of the defined conditions have been met. Variables used in customer interaction router conditions are defined and named using a web interface and then those variable names are used in page tags on the instrumented site. The customer interaction router manipulates any named element on a tagged page using JavaScript and DHTML commands transmitted to the instrumented site through the JavaScript includes.

As provided herein, systems and methods of the present invention enable interaction routing across multi-channel connection methods. For example, a customer interaction router is used to instrument a portal that provides a jumping-off point for multiple other communications channels such as chat, email, web forums, or phone. The customer interaction router controls which contact options that get offered to a particular user based on conditions defined by the customer interaction router administrator or manager. The customer interaction router controls the routing of a user through a site by changing the options presented to the user based on the customer interaction router server detecting that specific conditions are being met.

The following provides a representative example. A user/customer accesses the customer interaction router—instrumented portal and searches for diamond rings for sale. The customer interaction router detects that the user is searching for diamond rings and determines if a defined condition is met. As a result of the conditions, the customer interaction router sends instructions to the client browser to hide categories or content that might distract the user from the high-margin purchase. The customer interaction router also sends instructions to the client browser to pop a pro-active chat which is staffed by a special purchases skill set.

As provided herein, embodiments of the present invention embrace self-learning behavioral capabilities of the dynamic customer interaction router. For example, the customer interaction router can use artificial intelligence on current and past user behavior to suggest rules to an administrator to maximize defined key performance indicators. The customer interaction router can consume web analytics and suggest new behaviors to maximize key performance indicators. The customer interaction router can watch the status of systems and make instantaneous changes to rules to compensate or capitalize on system conditions.

Embodiments of the present invention embrace automated variable self-discovery capabilities of a dynamic customer interaction router. For example, the customer interaction router uses URL query string parsing technology to detect variables in use on an instrumented site or HTTP-enabled technology or interaction channel. Variables identified through the automated variable self-discovery process are made immediately available for use in building conditions.

At least some embodiments of the present invention embrace a behavior modification system (CXP), such as, for example, a third-party website behavior modification system.

At least some embodiments embrace a dynamic presentation and customization of web content based on user behavior using a third-party service. For example, at least some embodiments embrace the domain of software-as-a-service provided over the Internet. One embodiment is a rules-based website behavior modification system related to customer interaction routing, customer experience management, dynamic behavior generation, dynamic offer generation, content modification, and data integration. The CXP provides a mechanism for presenting customized dynamic content based on rules defined to evaluate user behavior and/or any other parameters (e.g., a user's physical location, inventory levels, CRM data, weather data, etc.). In one embodiment, it does so as a third-party application service provider model, requiring only tagging of pages. Thus, the CXP is a rules-based website behavior modification system which can be used to present dynamic, customized content. Moreover, the CXP modifies a site without requiring a proxy and without deploying any software on the site.

At least some embodiments of the present invention embrace use of page types in a third-party website behavior modification system. Embodiments embrace finding and/or matching patterns in URLs. For example, at least some embodiments embrace the domain of software-as-a-service provided over the Internet. It is also a rules-based website behavior modification system related to customer interaction routing, customer experience management, dynamic behavior generation, dynamic offer generation, content modification, and data integration. Rules engines typically depend on a conceptual structure to organize the application of rules. The CXP rules are organized according to page types which are based on URL pattern matching. Business users can define the page types themselves using a bookmarklet (see below). Examples of page types are welcome pages, store pages, thumbnail catalog pages, product details pages, cart pages, or support document pages. Business users can browse to an example page that represents a page type that they want to define and then use the bookmarklet to capture the URL pattern as a page type. Thus, the CXP uses user-defined page types to organize rules. The page types can be managed by a business user using a bookmarklet, and are identified by URL pattern matching.

By way of example, when CXP is enabled on a website, one can decide to create a rule on a particular page. Clicking on a book mark, such as a CXP specific book mark referred to as a bookmarklet, passes URL information to the CXP server and redirects the user to the CXP server. The URL information is displayed. Accordingly, it can be determined to have the whole page as the page type or to have only a chunk of the URL pattern, and elements may be captured as variables to use within the page type. Thus, the user is given the ability to define the page type based on URL pattern elements that are available when they click on the bookmarklet. Once a page type is defined, the JavaScript includes that are loaded communicate with the CXP server to determine whether they match a given page type. If they do match a page type, the CXP server sends JavaScript that deals with the rules for that specific page type.

In a representative example, a user is on www.example.com/<date>/article1.html, which is tagged for CXP. The user has the bookmarklet, which is account specific. The user clicks on the bookmarklet. The URL is parsed by the bookmarklet and sent to the CXP server, which displays it for the user. The user can click on any portion of the URL and make that portion a variable. Thus, for example “<date>” may be defined as a date variable and “article.html” may be defined as an article variable. Accordingly, this page type would match whenever example.com was the domain and there was a date variable and an article variable. It captures the date variable and the article variable for logic in the page type. Accordingly, rules can be established using the variables that are established.

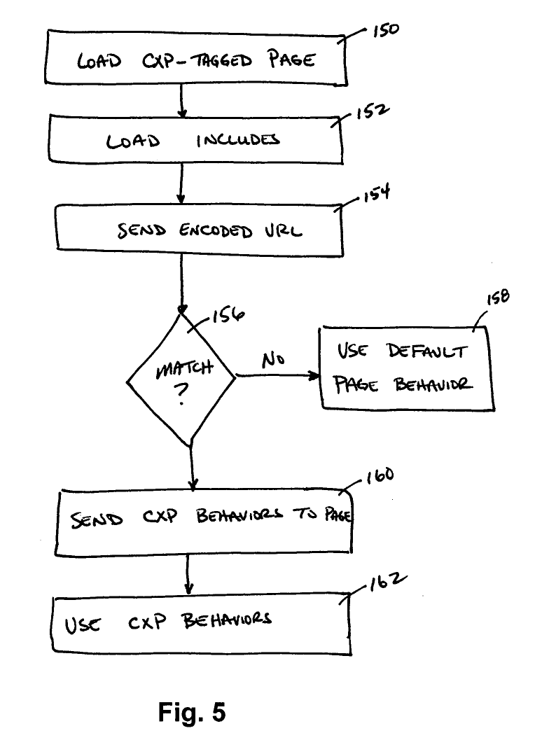

With reference now to FIG. 5, a representative embodiment is provided that illustrates the use of page types in a third-party website behavior modification system. In FIG. 5, execution begins at step 150 where a CXP tagged page loads in the browser. At step 152, CXP JavaScript includes load in a browser. At step 154, CXP JavaScript includes send an encoded URL for the current page to CXP server. Execution then proceeds to decision block 156 where a determination is made as to whether or not the URL matches a defined page type. If it is determined at decision block 156 that the URL does not match a defined page type, the default page behavior is used at step 158. Alternatively, if it is determined at decision block 156 that the URL does match a defined page type, execution proceeds to step 160, where the CXP behaviors are sent to the page and then used at step 162.

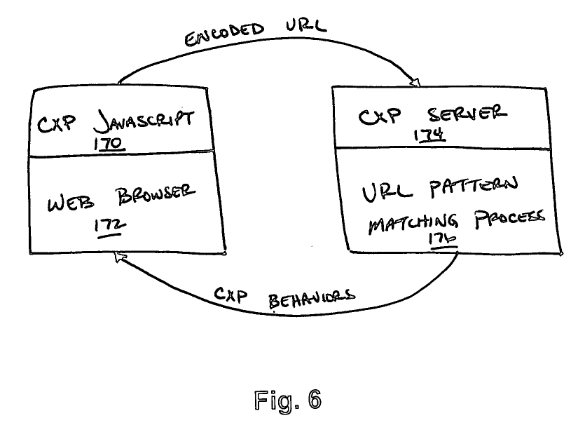

With reference now to FIG. 6, another representative embodiment is provided to illustrate the use of page types in a third-party website behavior modification system. In FIG. 6, CXP JavaScript 170 has provided an association with web browser 172. Additionally, CXP server 174 has provided an association with URL pattern matching process 176. In accordance with a representative embodiment, CXP transcript 170 provides an encoded URL to CXP server 174. Additionally URL matching process 176 provides CXP behaviors to web browser to 172.

At least some embodiments of the present invention embrace use of bookmarklet technology to identify page types and/or to identify page variables for use in a third-party website behavior modification system. For example, at least some embodiments embrace the domain of software-as-a-service provided over the Internet. It is also a rules-based website behavior modification system related to customer interaction routing, customer experience management, dynamic behavior generation, dynamic offer generation, content modification, and data integration. In order to use Page Types to organize a third-party website behavior modification system there is typically some mechanism to identify the Page Types. Thus, a user browses to a page that he/she wants to use in identifying a page type. The user then clicks on their CXP Page Type bookmarklet which builds the URL structure for use in the CXP. The user then has the opportunity to identify elements of the URL pattern identified by the bookmarklet that are required elements for the page type. Thus, the CXP uses bookmarklet technology to organize elements of a third-party website behavior modification system. The bookmarklet application used in CXP parses URL elements and passes the information into the CXP server for the creation of a Page Type.

The CXP can make use of elements of a page's URL as variables. The CXP Page Type bookmarklet parses all elements of a URL and identifies the components of the URL. URL arguments are presented independently and the user is given the opportunity to identify elements as tracked or ignored. Tracked elements are available for use as variables for conditions on that particular page type. Some sites have clean, Representational State Transfer(REST)-formatted URLs, such as: www.example.com/widget/jumbo. The CXP bookmarklet makes all elements of this URL pattern required for a page type, unless the user renames one of the URL elements, essentially identifying it as a variable to be tracked on the page type, but removing it from the required elements for the page type. In other words, if the user renames a URL element the value of that element becomes a variable instead of a required element for the page type. Some sites have URLs which include additional arguments, the beginning of which is usually denoted by a question mark. An example of such a URL is: www.example.com/page.php?product=widget&size=jumbo. The CXP bookmarklet can take the name/value pairs after the question mark and make them available to the user, who then identifies them as required for the page type, as a variable to track on the page type, or as an element to be ignored. Thus, the CXP uses a bookmarklet to identify URL elements for use as variables. The URL elements can be identified as required for the Page Type, track the element as a variable, or ignore the element.

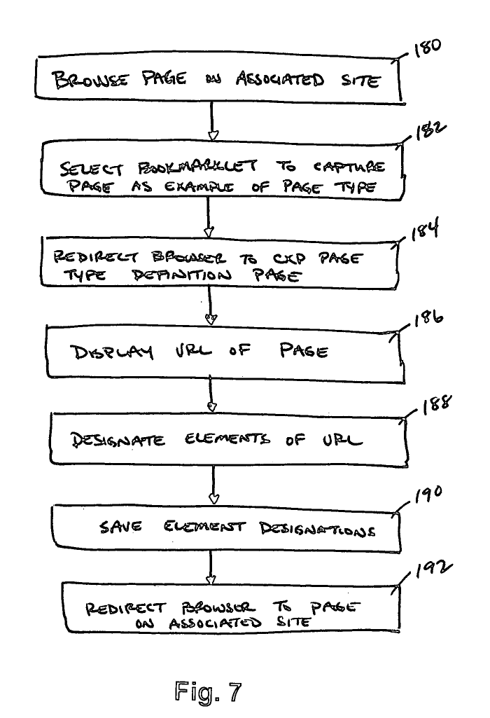

With reference now to FIG. 7, a representative embodiment is provided that illustrates use of bookmarklets to identify page types and/or variables. In FIG. 7, execution begins at step 180 where CXP rules administrator browses to a page on an associated site and selects a bookmarklet to capture the page as an example for a page type at step 182. Rules administrator browser is redirected to a CXP page type definition page at step 184 and the URL of the page identified is displayed at step 186. Execution then proceeds to step 188, where the rules administrator designates ailments of the URL as required, ignored, or as variables. At step 190 the rules administrator saves the element designations and the browser is redirected back to the page on the associated site at step 192.

At least some embodiments of the present invention embrace the use of distributed ruby (DRB) in aggregating data from server clusters into one database. For example, at least some embodiments embrace the domain of data aggregation from clustered applications into one database. CXP is designed to scale horizontally, meaning greater capacity is achieved through the addition of commodity hardware instead of through buying hardware with greater capacity. In order to achieve this architecture a reliable method for data aggregation is utilized. The CXP uses a Distributed Ruby (DRB) data aggregation server on each application server to track interactions with the CXP server. A separate DRB server on the database server polls each registered DRB data aggregator on the application servers to retrieve interactions to be stored in the database. The data aggregators register themselves with the database DRB server automatically when they come online, enabling quick scaling of the infrastructure. The CXP uses DRB servers to aggregate and collect interaction data. The DRB data aggregators are registered with the DRB server on the database which tracks the health and availability of each aggregator. The DRB server on the database manages the frequency of data insertion into the database.

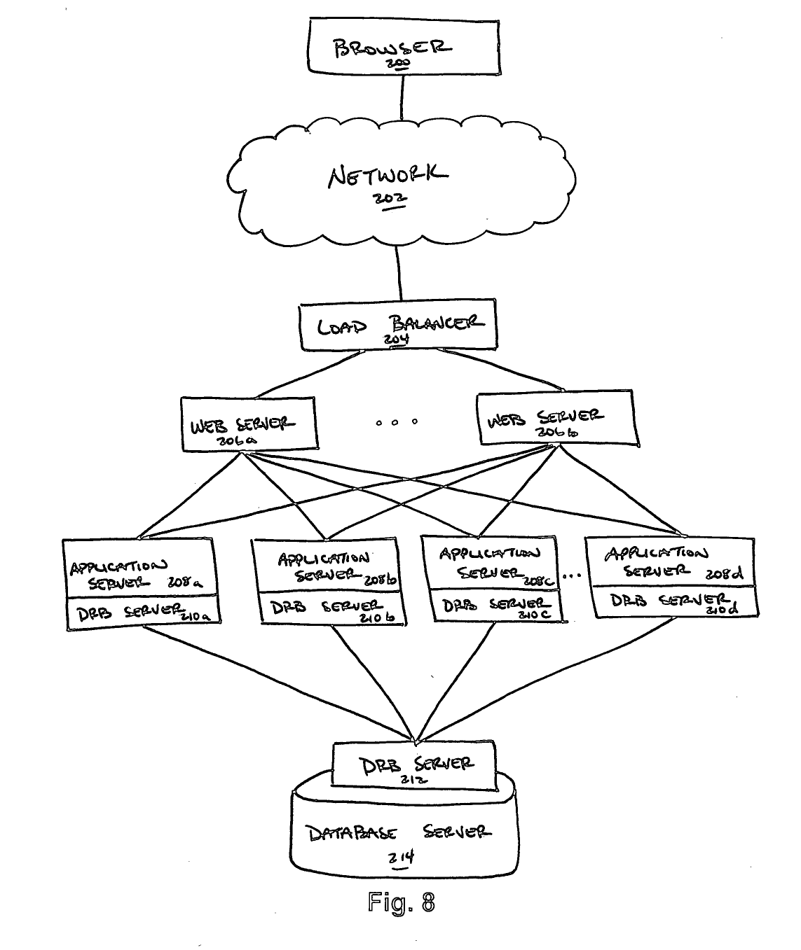

With reference now to FIG. 8, a representative embodiment is provided that illustrates use of Distributed Ruby (DRB) in aggregating data from server clusters into one database. In FIG. 8, a network interface or browser 200 and a load balancer 204 are connected to a network 202. Those skilled in the art will appreciate that network 202 represents any type of network configuration. In one embodiment, network 202 is a wide area network, such as the internet. Load balancer 204 communicates with one ore more web servers 206. In the illustrated embodiment, each web server 206 communicates with a group of application servers 208 that are running CXP and that can service individual requests. Each application server 208 has a DRB message queue that is running on it (illustrated as DRB servers 210). Requests accumulate within the message queue. On database server 214 there is a DRB server 212 to which each of the application servers 208 are registered. The registration is done automatically when a new application server is brought online. The DRB server 212 on database server 214 periodically pulls the DRB processes on the application servers 208 to determine the transactions that have occurred. The transaction information are pulled in and inserted into the database server 214. The queues are then cleared out. This happens on a regular basis. For example, in one embodiment, it is performed every minute. However, those skilled in the art will appreciate that other embodiments of the present invention embrace having it take place during a period that is less than one minute or more than one minute. Accordingly, if an application server goes down, the maximum amount of data is the length of the period (e.g., one minute) for which the information queued is pulled. Additionally, the transaction load on the database is managed.

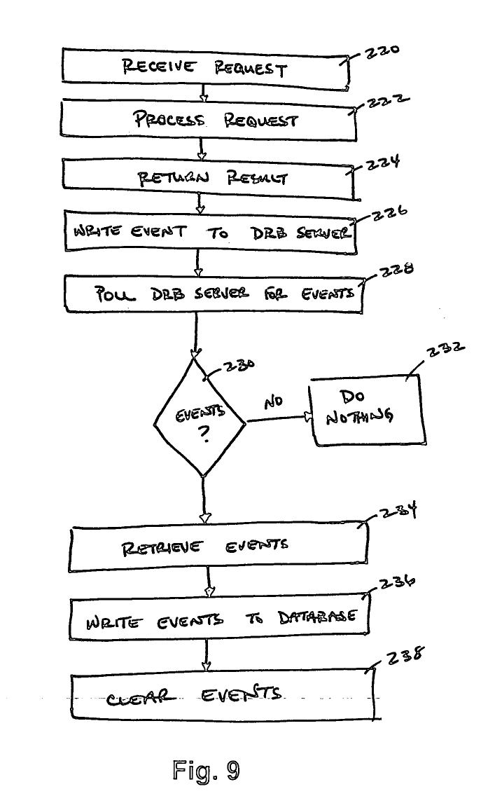

With reference now to FIG. 9, a representative embodiment is provided that illustrates use of distributed ruby (DRB) in aggregating data from server clusters into one database. In FIG. 9, execution begins at step 220 where an application server receives requests from web server. The application server processes the requests at step 222 and then returns the request at step 224. The application server writes these in to a local DRB server at step 226. Execution then proceeds to step 228 where a database server DRB server pulls the application server's DRB server for events. Execution then proceeds to decision block 230 for determination as to whether or not any events have occurred. If it is determined at decision block 230 that no events have occurred, execution proceeds to step 232 where nothing is done. Alternatively, if it is determined at decision block 230 that events have occurred, execution proceeds to step 234, where the database server's DRB server retrieves all events and writes the events to the database at step 236. At step 238 the database server's DRB server clears out all events on the application server's DRB server.

At least some embodiments of the present invention embrace use of client-hosted XML data files for data integration at the web browser level with a third-party website behavior modification system. For example, at least some embodiments are related to data integrations between systems. The CXP can key off of data gleaned from the user's behavior on the site or from other integrated data sources such as IP address to geographic location mapping data. however more value is derived from integrating the CXP with data sources that contain data specific to our client's business, such as CRM or inventory data they may already have in existing systems. Clients wishing to integrate their data with the CXP can do so by periodically publishing an XML file on one of their web servers with the data they wish to use in CXP. Access to this file would be controlled by HTTP authorization or some other agreed-upon technology. CXP JavaScript files, loaded in a customer's browser, refer to the XML file for any data needed for the particular page type. No data is uploaded to the CXP server, except data needed to evaluate conditions. However, the data sent to the CXP server is brokered by the JavaScript files, making each customer's browser an agent in the data integration and preventing CXP from having to do heavy back-end data integrations with third parties. Thus, the CXP can integrate with systems that publish XML over HTTP containing the data they wish to integrate. The client-published XML is consumed by the CXP JavaScript files and evaluated to see if conditions for rules have been met. The data encapsullated in XML is not integrated into the back-end server of the CXP. The data integration can be as infrequent or as frequent as the client wishes as data freshness is completely in the hands of the client because they publish the XML.

At least some embodiments of the present invention embrace use of a JavaScript include to manage interactions with a third-party website behavior modification system, including using, for example, JavaScript objects and DOM in communications between a web client and the CXP, and providing a method of tagging webpages to interact with a third-party website behavior modification system. CXP utilizes a JavaScript include technology to handle all communications to and parse all messages from the CXP server. This program also accesses data from external services which have published data from the CXP in XML format. The technology also determines which additional JavaScript programs are needed for a particular Page Type and retrieves them from the CXP server. To instrument a site, the site owner adds, for example, a JavaScript include tag to their site which references a URL on the CXP's domain. When the client's site is accessed by a web browser the browser requests the CXP page referenced in the JavaScript include tag. The CXP server generates dynamic JavaScript for this page which is then loaded into the client's browser and executed. This dynamic JavaScript can spawn behaviors and load further dynamic javascript includes. Thus, for example, Main.js, the main JavaScript include, retrieves other JavaScript programs from the CXP server as needed, depending on the particular Page Type. Actions defined in the CXP server for a particular Page Type are ultimately executed by the JavaScript include. The JavaScript include may also evaluate the values of variables to determine if a defined condition has been met. The CXP server communicates with the JavaScript includes to pass values for variable pertinent to that page type which do not occur in the page, such as IP-geographic location mapping. The JavaScript include also pulls data from XML files published by the client in order to evaluate external data contained in the XML files that may be needed to evaluate conditions defined for the page type.

As provided above, at least some embodiments embrace using, for example, JavaScript objects and DOM in communications between a web client and the CXP. For example, at least some embodiments embrace the domain of Internet communication technologies related to distributed web applications and third party software services. Communications with the CXP enable reporting and additional dynamic behaviors. When such an event needs to take place, the system causes JavaScript, for example, to assemble a URL based on a predetermined format and creates a new script object via the DOM and inserts this object into the head tag of the html document. The browser then automatically requests and executes this object. The CXP uses, for example, proprietary JavaScript objects and URLs working through the DOM to send data from the browser to the CXP server. Moreover, the CXP does not use a proxy on the client's web server to pass traffic through to the CXP server.

As provided above, at least some embodiments of the present invention embrace a method of tagging web pages to interact with a third-party website behavior modification system. For example, in order to affect the behavior of an existing website without rebuilding the site or modifying its existing functionality an external service is typically connected to the site. This may be done by tagging the existing site with tags that enable the augmenting service to communicate with and manipulate the existing site. The CXP utilizes, for example, a JavaScript include and CXP event controllers which can key off of any event handled by JavaScript to communicate with the CXP server. The JavaScript include also parses the message returned from the CXP server and executes any instructions received. Thus, the CXP's tagging technology enables secure, two-way communications with the CXP server. The CXP tags interact with elements already on the page to initiate communications with the CXP server.

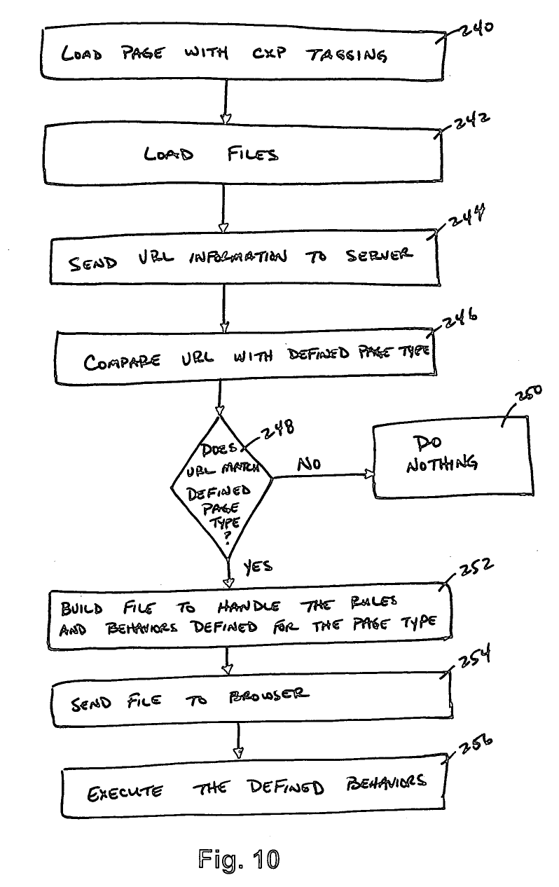

With reference now to FIG. 10, a representative embodiment is provided that illustrates use of an include to manage interactions with a third-party website behavior modification system. In FIG. 10, execution begins at step 240, where a page with CXP tagging loads in a browser. CXP JavaScript files then are loaded in the browser at step 242. URL information is sent to CXP server at step 244. Execution then proceeds to step 246 where the CXP server compares the URL with defined page types. A determination is then made at decision 248 as to whether or not the URL matches the page type. If it is determined at decision block 248 that the URL does not match a defined page type, execution proceeds to step 250 where nothing is done. Alternatively, if it is determined at decision block 248 that the URL does match a defined page type, execution proceeds to step 252, where the CXP server builds a JavaScript file to handle the rules and behaviors defined for the page type. This information is then sent to the browser at step 254, and the browser executes the defined behaviors at step 256.Accordingly, those skilled in the art will appreciate that embodiments of the present invention generate dynamic JavaScript for the needs of the moment. For example, there exist the basic includes. The browser and the includes load. The includes send URL patterns to the CXP server, which dynamically generate JavaScript that are specific to that particular page type and any variables that are present. Accordingly, in at least some embodiments, it is not a static JavaScript file for the rules for each individulal page type, but instead it is dynamically generated and distributed to the web browser where it is used to execute rules.

At least some embodiments of the present invention embrace the architecture of a third-party website behavior modification system. For example, at least some embodiments embrace the domain of third party website modification tools provided as a service over the internet. The architecture of CXP enables a customer to add the features of CXP without modifying the underlying architecture of their site or their web hosting platform. CXP is a service that enables existing sites to increase the richness of interactions with users. It includes a rules server, files that get included into the pages to manage interactions between the client browser and the rules server, and the existing site. CXP provides statistics on the performance of the tool, A/B testing, variable discovery, and operational diagnostics capabilities. The architecture of CXP is comprised of a rules server and database infrastructure, include files, and the existing site.

Accordingly, those skilled in the art will appreciate that the methods and processes of the present invention embrace a website behavior augmentation system.

While reference is made to particular programming language, those skilled in the art will appreciate that the methods and processes of the present invention embrace a variety of programming languages and/or formats to implement the methods and processes of the present invention.

Thus, as discussed herein, the embodiments of the present invention embrace providing a dynamic customer interaction router. In particular, the present invention relates to systems and methods for providing intelligent routing of customer inquiries via multi-channel communication tools.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for providing intelligent routing of customer inquiries through a multi-channel communication tool, the method comprising:
receiving contact from a user at a portal through an interaction channel;
obtaining user information specific to the user, including user behavior information obtained by self-learning behavioral capabilities of a dynamic interaction router; and
using the dynamic interaction router to route the user to a preferred channel based upon one or more factors.

2. A method as recited in claim 1, wherein said preferred channel is one of:
(i) a chat session;
(ii) email;
(iii) a webpage;
(iv) a telephone; and
(v) a text message.

3. A method as recited in claim 2, wherein said interaction channel is one of:
(i) a chat session;
(ii) email;
(iii) a webpage;
(iv) a telephone; and
(v) a text message.

4. A method as recited in claim 3, wherein said interaction channel is different from said preferred channel.

5. A method as recited in claim 2, wherein said one or more factors comprise one of:
(i) what is needed by the user;
(ii) a frequency to which the user returns to the portal;
(iii) a type of customer;
(iv) a type of product desired by the user;
(v) a type of service desired by the user;
(vi) a level of expertise; and
(vii) a communication medium.

6. A method as recited in claim 1, wherein said obtaining user information specific to the user comprises analyzing behaviors of the user in real-time.

7. A method as recited in claim 1, wherein said using the dynamic interaction router to route the user to a preferred channel based upon one or more factors comprises utilizing a rules engine and predefined rules.

8. A method for delivering active personalization and one-to-one marketing to a customer, the method comprising:
providing a customer experience platform having a rules engine that is configured to optimize a website;
analyzing behaviors of a customer in real-time; and
providing dynamic information to the customer to motivate the customer to take action.

9. A method as recited in claim 8, wherein the dynamic information comprises dynamic messaging.

10. A method as recited in claim 8, wherein the dynamic information comprises dynamic offers.

11. A method as recited in claim 10, wherein the dynamic offers are marketing offers that are customized to the customer and are delivered at the moment the customer is making a decision to purchase, and wherein the marketing offers affect the customer's decision to make the purchase.

12. A method as recited in claim 10, wherein the dynamic offers are based upon online actions of the customer.

13. A method as recited in claim 10, wherein the dynamic offers are based upon a buying history of the customer.

14. A method as recited in claim 10, wherein the dynamic offers are based upon a geographic location.

15. A method as recited in claim 10, wherein the dynamic offers are based upon customer demographics.

16. A method as recited in claim 8, wherein the dynamic information comprises dynamic content based upon rules that are designed to evaluate behaviors of the customer.

17. A method as recited in claim 16, wherein the rules are organized according to page types, which are based upon URL pattern matching.

18. A method as recited in claim 17, wherein bookmarklets are used to identify page variables.

19. A method as recited in claim 8, wherein said providing dynamic information is performed as a third-party application service that comprises a tagging of web page information without deploying any software on a website.

20. A computer program product for implementing within a computer system a method for managing user interaction with a third-party website behavior modification system, the computer program product comprising:
a computer readable medium for providing computer program code means utilized to implement the method, wherein the computer program code means is comprised of executable code for implementing the steps of:
providing an include tag to a website, wherein the tag references a URL on a domain;
upon access of the website by a browser, requesting the URL referenced in the tag;
generating dynamic scripting language for the page corresponding to the URL;
loading the dynamic scripting language into the browser;
executing the dynamic scripting language, which spawns behaviors and loads additional scripting language includes.
